(19) United States
(12) Patent Application Publication
(10) Pub. No.: US 2025/0209331 A1
(43) Pub. Date: Jun. 26, 2025

(54) MACHINE LEARNING SYSTEMS WITH COUNTERFACTUAL INTERVENTIONS

(71) Applicant: DeepMind Technologies Limited, London (GB)

(72) Inventors: Neil Charles Rabinowitz, St. Albans (GB); Nicholas Andrew Roy, London (GB); Junkyung Kim, London (GB)

(21) Appl. No.: 18/849,935

(22) PCT Filed: May 19, 2023
(86) PCT No.: PCT/EP2023/063488

§ 371 Date: Sep. 23, 2024

Related U.S. Application Data
(60) Provisional application No. 63/343,819, filed on May 19, 2022.

(51) Int. Cl. G06N 3/084; G06N 3/0455

(52) U.S. Cl. CPC G06N 3/084; G06N 3/0455

(57) ABSTRACT

Systems, methods, and computer program, for training and using a machine learning system to control an agent to perform a task. The machine learning system is trained using counterfactual internal states so that it can provide an output that explains the behavior of the system in causal terms e.g. in terms of aspects of its environment that cause the system to select particular actions for the agent.

### BACKGROUND

This specification generally relates to controlling agents using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification relates to systems and methods, implemented as computer programs on one or more computers in one or more locations, for training and using a machine learning system to control an agent to perform a task. The machine learning agent control system is trained using counterfactual internal states so that it can provide an output that explains the behavior of the system in causal terms, e.g. in terms of aspects of its environment that cause the system to select particular actions for the agent.

In one aspect there is described a computer-implemented method of training a machine learning agent control system, e.g. a reinforcement learning system, configured to monitor the control of an agent in an environment performing a task.

The machine learning system is configured to, for each of a succession of time steps, obtain an observation characterizing a state of the environment for a current time step. The system is further configured to process an internal state of the machine learning system at the current time step using an action selection subsystem to generate an action selection policy output. The internal state of the machine learning system at the current time step depends on the observation for the current time step. The system is configured to process the internal state of the machine learning system at the current time step using a decoder neural network to generate a decoder output. The decoder output describes the internal state of the machine learning system at the current time step. The system selects an action to be performed by the agent at the current time step in response to the observation using the action selection policy output, and causes the agent to perform the selected action. The system also provides a signal derived from the decoder output for the current time step as a monitoring signal for monitoring the control of the agent in the environment.

The method comprises training the machine learning system by determining the internal state of the machine learning system at a next time step by processing, using an internal state updating subsystem, a combination of the decoder output for the current time step, the observation for the next time step, and a counterfactual internal state. The counterfactual internal state is different to the internal state of the machine learning system at the current time step.

In some implementations the counterfactual internal state comprises the internal state of the machine learning system at an earlier time step than the current time step, e.g. the internal state of the machine learning system at a first time step of an episode of the agent interacting with the environment during which time the agent attempts to perform the task.

In some implementations the machine learning system has already been trained; for example the above-described process may be used to fine-tune the system. In some implementations the process is performed offline, using previously stored data, without requiring the agent to interact further with the environment.

Thus in another aspect a process obtains a dataset of training data comprising data defining an observation and an action for each of a succession of time steps, and trains the machine learning system using this and based on one or more counterfactual internal states.

After the machine learning (agent control) system has been trained the monitoring signal, e.g. the decoder output, may be used to monitor the control of an agent in an environment by the system, to perform a task. For example the monitoring signal can be used to obtain information that explains the behavior of the system/agent in terms of the system's beliefs about the environment. Optionally the decoder output can be modified, to modify the system's beliefs about the environment, and thereby to intervene in the control of the agent.

The subject matter described in this specification can be implemented in particular embodiments so as to realize one or more of the following advantages.

The described techniques can provide a machine learning agent control system with an output that provides a causal explanation of the behavior of the system. That is, the information in the output is information that is used by the system to control the behavior of the agent rather than information that merely correlates with the behavior of the agent. In implementations this is achieved by feeding the output back into the machine learning system, and using counterfactual internal states during training to ensure that the output is relied upon.

In implementations the information in the output is semantically grounded in features of the environment, i.e. the output can comprise a description in terms of features of the environment. The form of the output is flexible and it can produce representations in a variety of different forms such as classes, graphs, and strings, and in particular natural language descriptions.

Changing the description produces behavior that is consistent with the changed description and thus the described techniques also enable intervention to allow the behavior of the system to be controlled, e.g. for safety purposes. The changed description can also be semantically-grounded manner, i.e. human-interpretable, e.g. in the form of natural language. In this way the agent, more particularly the machine learning system controlling the agent, can be guided, or a limit on the behavior of the agent can be imposed in a safety-critical application. For example, in the case of a robot the system could be instructed about the location of an object to pick up or manipulate, or in the case of an autonomous vehicle where the speed limit is, say, 40 mph the system could be instructed that the speed limit should instead be 30 mph.

Some implementations of the described techniques enable the behavior of a machine learning agent control system (e.g. in simulation) to be analyzed offline. The output explaining the behavior of the system can then be used to determine, optionally automatically, whether or not the machine learning agent control system should afterwards be to control the agent to perform the task (e.g. in the real world).

The techniques are not limited to particular types of machine learning agent control system, and scale to machine learning systems with many parameters. For example they can be used with machine learning agent control systems that use imitation learning, e.g. behavioral cloning, reverse imitation learning, or Generative Adversarial Imitation Learning (GAIL, arXiv: 1606.03476, Ho et al.), or machine learning agent control systems that use reinforcement learning based on rewards received in response to actions performed.

They can have relatively little impact on the performance of the machine learning system, particularly if applied offline, and they can enable the behavior of a machine learning system to be explained without many hours of human reverse engineering.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a machine learning agent control system.

FIGS. 2A and 2B show schematic illustrations of processing in a machine learning system.

FIGS. 3A and 3B show schematic illustrations of processing using a counterfactual internal state.

FIG. 4 is a flow diagram of a first example process for training a machine learning system.

FIG. 5 is a flow diagram of a second example process for training a machine learning system.

FIG. 6 is a flow diagram of an example process for monitoring a machine learning system.

FIG. 7 illustrates the performance of trained machine learning systems.

Like reference numbers and designations in the various drawings indicate like elements.

### DETAILED DESCRIPTION

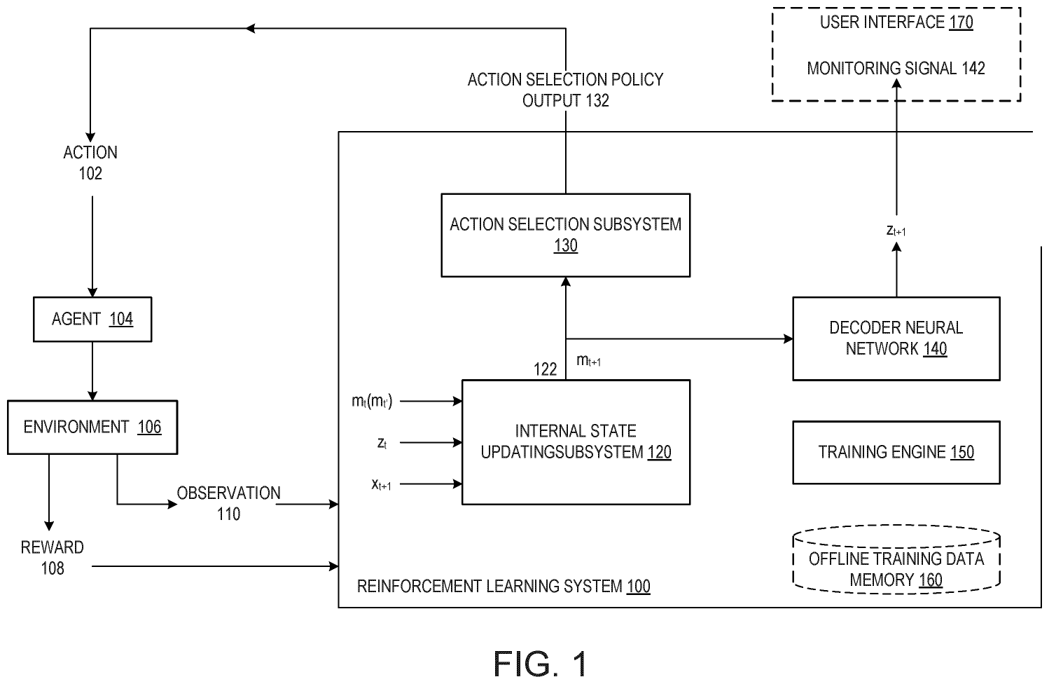

FIG. 1 shows an example of a machine learning system 100 for agent control that may be implemented as one or more computer programs on one or more computers in one or more locations. The machine learning system 100 is used to control an agent 104 interacting with an environment 106 to perform a task, and generates human-interpretable decoded states (zₜ) that explain behavior of the system. In implementations the system is trained to rely on these states when controlling the agent 102, and thus they provide a causal explanation of the behavior of the system (rather than merely correlating with the behavior of the system). For example if one of these states is altered, e.g. by a user via a user interface 170, then the behavior of the system is also altered.

The machine learning system 100 can comprise any type of agent control system, e.g. using imitation learning such as behavioral cloning and/or reinforcement learning. Although the machine learning system 100 may be loosely referred to as a reinforcement learning system this should be understood as including, e.g. imitation learning. Moreover, implementations of the described techniques allow an agent to act in the environment but do not require the agent to act in the environment-for example the CST-MR and CST-PD variants described later can be performed entirely in replay without requiring the agent to act (according to a counterfactual policy) in a live environment.

The machine learning system 100 has one or more inputs to receive data from the environment characterizing a state of the environment, e.g. data from one or more sensors of the environment. Data characterizing a state of the environment is referred to herein as an observation 110. An observation can be a multimodal observation, for example a combination of a still or moving image and natural language. The machine learning system 100 obtains an observation 110 of the environment 104 at each of a succession of time steps.

A representation of the observation at a time t is later denoted xₜ; it may include a representation of a history of observations at one or more previous time steps. An image observation, for example, may be encoded using a ResNet (residual neural network); or a text input, e.g. in a natural language, may be encoded using an LSTM (Long Short-Term Memory) neural network, after tokenization and vectorization. A multimodal observation may include a natural language description of a task to be performed, optionally repeated at each observation.

The data from the environment can also include task rewards. Generally a task reward 108 is represented by a scalar numeric value (which may be zero) characterizing progress of the agent towards a task goal, and can be based on any event in, or aspect of, the environment. Task rewards may be received as a task progresses or only at the end of a task, e.g. to indicate successful completion of the task.

The machine learning system 100 controls the agent by, at each of multiple action selection time steps, processing the observation 110 to select an action 102 to be performed by the agent 104. The action 102 may be continuous or discrete; it may comprise a set of multiple individual or primitive actions to be performed at a time step e.g. a mixture of continuous and discrete actions. At each time step, the state of the environment at the time step depends on the state of the environment at the previous time step and the action performed by the agent at the previous time step. Performance of the selected actions by the agent 104 generally causes the environment 104 to transition into new states. By repeatedly causing the agent 102 to act in the environment 104, the system 100 can control the agent 102 to complete a specified task.

The machine learning system 100 includes an action selection subsystem 130 that generates an action selection policy output 132 for selecting the action 102. In general any type of action selection subsystem may be used for the action selection subsystem 130. In some implementations, but not necessarily, the action selection subsystem includes an action selection policy neural network.

There are many ways in which the action selection policy output 132 can be used to select actions. For example the action selection policy output 132 may define the action directly, e.g., it may comprise a value used to define a continuous value for an action, such as a torque or velocity. As another example it may define, e.g. parameterize, a continuous or categorical distribution from which a value defining the action may be selected; or it may define a distribution as a set of scores, one for each action of a set of possible actions. Such a distribution can be used for selecting the action, e.g. by sampling from the distribution or by selecting an action with the highest probability.

The machine learning system 100 maintains an internal state, mₜ, at a time t, and includes an internal state updating subsystem 120. The internal state updating subsystem 120 is configured to process the internal state, mₜ, at a current time step t, a decoder output for the current time step, zₜ (described later), and a representation of an observation for the next time step, xₜ₊₁, to generate an updated internal state 122 for the next time step, mₜ₊₁. The internal state at the current time step, mₜ, is processed by the action selection subsystem 130 to generate the action selection policy output 132 for selecting the action 102 at the current time step.

The techniques described herein do not rely on any particular architecture for the internal state updating subsystem 120. As one example, in some implementations the internal state updating subsystem 120 comprises a recurrent neural network such as an LSTM neural network. Then the internal state, mₜ, may comprise a recurrent state of the recurrent neural network. As another example, in some implementations the internal state updating subsystem 120 comprises a transformer neural network. In general a transformer network can be characterized as a neural network, in particular an autoregressive neural network, with a succession of self-attention neural network layers.

A self-attention neural network layer has an attention layer input for each element of the input and is configured to apply an attention mechanism over the attention layer input to generate an attention layer output for each element of the input; there are many possible attention mechanisms. When the internal state updating subsystem 120 comprises a transformer neural network the internal state, mₜ, may, e.g., comprise a variable-length array of embeddings of previous observations x_{o:t}. In some of these implementations, but not necessarily, the internal state updating subsystem 120 includes a memory.

The machine learning system 100 also includes decoder neural network 140 that is configured to process the internal state at a current time step, mₜ, in accordance with decoder neural network parameters, to generate a decoder output for the current time step, zₜ. In general the decoder neural network 140 may have any suitable architecture and may include, e.g., one or more feed forward neural network layers, one or more convolutional neural network layers, one or more attention neural network layers, or one or more normalization layers. In one example implementation the decoder neural network, e.g. a multilayer perceptron (MLP), parameterizes a distribution q(zₜ) from which a value of zₜ is sampled, zₜ˜q(zₜ). In another example, zₜ is provided by an LSTM.

The machine learning system 100 is trained so that the decoder output, zₜ, describes information in mₜ that is actually used in determining the action selection policy output 132, rather than merely reflecting the information content in mₜ.

The decoder output, zₜ, is used to provide a monitoring signal 132 for monitoring control of the agent in the environment by the machine learning system 100, e.g. as a signal on a wired or wireless network or as an output from a local or remote user interface 170. The monitoring signal 132 may be the decoder output, zₜ, or it may be derived from processing the decoder output zₜ. In some implementations the decoder output zₜ provides a natural language explanation of the behavior of the machine learning system 100.

In implementations the decoder output zₜ, and the monitoring signal 132, each comprise a description of the system's “beliefs” about the environment 104, i.e. a description of a supposed state of the environment that the system is relying on to control the agent. In some implementations the decoder output zₜ is expressed in semantically-meaningful terms, as described further later. The decoder output, zₜ, and monitoring signal 132, may be viewed as eavesdropping on “inner speech” of the system. In implementations the internal state, mₜ, and the decoder output, zₜ, for the current time step are combined, e.g. concatenated, and jointly processed by the internal state updating subsystem 120. Where necessary the decoder output, zₜ, may be converted into a form suitable for concatenation with mₜ.

As one illustration, in some implementations the decoder output for the current time step, zₜ, comprises a vector, e.g. a 1-hot vector, having elements that each represent a respective one of a plurality of discrete internal states, i.e. belief states, of the machine learning system 100. For example the environment may comprise a number, τ, of objects each with an associated 1-hot vector that represents a belief in relation to the object, e.g. each element of the vector identifying a state, configuration, description or location of the object. The distribution q(zₜ) may be defined as a product of independent categorical distributions q(zₜ)=Πᵢ₌₁^{τ}q(zₜⁱ) and zₜ may be determined by sampling from this distribution.

As another illustration, in some implementations the decoder output for the current time step comprises a natural language description of the internal state of the machine learning system, representing a belief of the machine learning system about the environment. The decoder neural network may define one or more sets of scores representing probabilities of tokens, such as wordpieces, words, parts of sentences, or sentences, which may be used to determine a natural language output e.g. by sampling or by selecting a most likely output. For example the decoder output for the current time step, zₜ, may be sampled from a distribution defined by the output of an LSTM. A value of zₜ may correspond to a sentence in a natural language, which may be constructed from successive samples according to the LSTM output, where each successive sample represents a token from a predetermined vocabulary of tokens.

The machine learning agent control system 100 may be any type of machine learning system, e.g. a reinforcement learning system, that maintains an internal state. For example it may be a model-based or model-free reinforcement learning system. It may be based on temporal-difference learning e.g. Q-learning, or on learning a policy directly e.g. via a policy gradient, or it may use another policy optimization technique such as MPO (arXiv: 1806.06920) or PPO (arXiv: 1707.06347). The machine learning system, e.g. reinforcement learning system, may implement an actor-critic technique. The machine learning system may be a distributed system.

The machine learning system 100 may be trained by iteratively updating learnable parameters of the system, e.g. neural network weights, using any form of reinforcement learning objective function, and using any appropriate gradient descent optimization algorithm, e.g., Adam. Merely as one example, the reinforcement learning objective function may include a V-trace update component (arXiv: 1802.01561). In general training of the machine learning system 100 may be controlled by a training engine 150; after training this is not needed.

The machine learning agent control system 100, e.g. reinforcement learning system, may be trained online, i.e. by taking actions in the environment 106 and updating the learnable parameters based on the rewards received e.g. to encourage an increase in a cumulative measure of the rewards received such as a time-discounted sum of rewards or “return”. Also or instead the machine learning system 100 may be trained offline, i.e. using previously collected data without interacting further with the environment. Offline training data may be stored in an offline training data memory 160; as an example it may comprise, for a succession of time steps, an observation of the environment 106, data indicating the action performed, an observation of a subsequent state of the environment at a next time step, and optionally data indicating a reward received in response to the action. Offline training data may be generated, by human and/or machine interactions with the environment 106.

In implementations of the described techniques, whether the machine learning system 100 learns online, offline, or both, the machine learning system 100 is trained to rely on the decoder output, zₜ, when selecting an action. This is done by, at one or more, or each, time step during the training, determining the internal state of the machine learning system at a next time step by processing, using the internal state updating subsystem 120, a combination of the decoder output for the current time step, zₜ, the observation for the next time step, xₜ₊₁, and a counterfactual internal state, m_{t′}. The counterfactual internal state, m_{t′}, is one that is different to the internal state of the machine learning system at the current time step, mₜ (e.g. it has the same format as, but a different value to, the current internal state).

For example, consider a state update function mₜ₊₁=ƒ_{θ}([xₜ₊₁, zₜ], mₜ) and an action selection policy πₜ=h_{θ}(mₜ), where θ represents the learned parameters. Because the decoder output zₜ is obtained by processing mₜ there is no need for the state update function to rely on the value of zₜ when performing the update, and thus no guarantee that zₜ reflects a causal belief state of the system. By training the system using the counterfactual internal state for at least some time steps, i.e. so that mₜ₊₁=ƒ_{θ}([xₜ₊₁, zₜ], m_{t′}), the system has to rely on the value of zₜ for at least some time steps to obtain information about the current state.

One way in which a counterfactual internal state, m_{t′}, can be obtained is to use the internal state from a different time step t′ as the counterfactual internal state. The updated internal state may then be denoted mₜ₊₁^{(t←t′)}=ƒ₇₄ ([xₜ₊₁, zₜ], m_{t′}), and the corresponding policy πₜ^{(t←t′)}=h_{θ}(mₜ₊₁^{(t←t′)}). The different time step can any other time step, e.g. an earlier time step. For example in some implementations the different time step can be the first time step, i.e. t′=0 (which amounts to dropout on the internal state, which may then be a zeroed or random state).

During the training an intervention can be performed to substitute the counterfactual internal state for the current internal state. This may be done according to an intervention schedule; e.g. randomly, or at each time step, or for each of a sequence of blocks of time steps of variable duration.

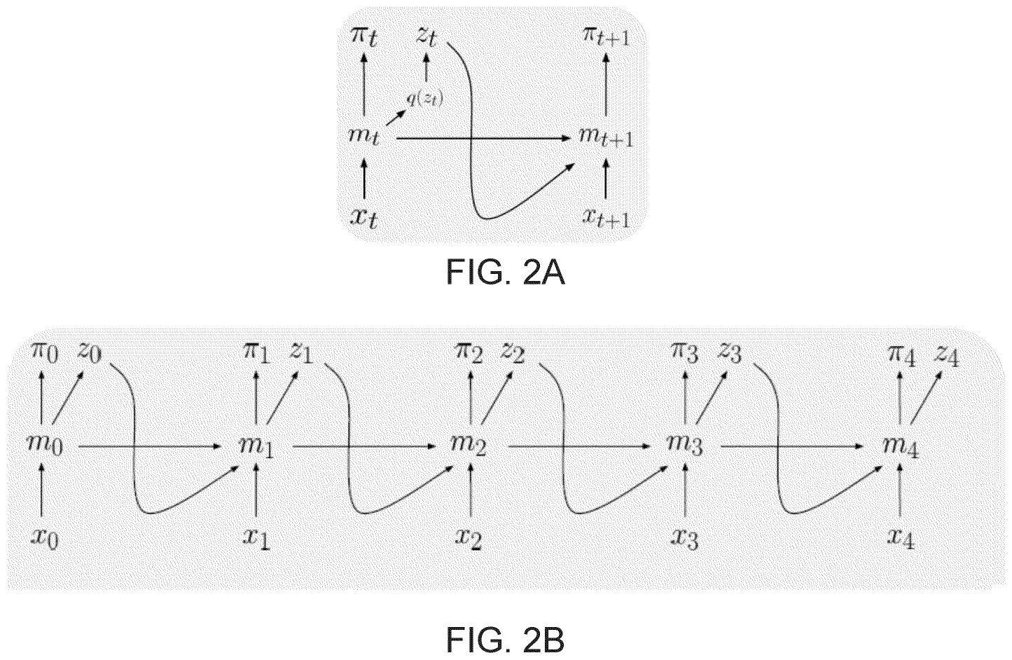

FIG. 2A is a schematic illustration of processing steps performed when processing observations xₜ, xₜ₊₁ to generate the action selection policy outputs πₜ, πₜ₊₁, and decoder output zₜ, updating the current internal state from mₜ to mₜ₊₁. FIG. 2B illustrates a sequence of such processing steps.

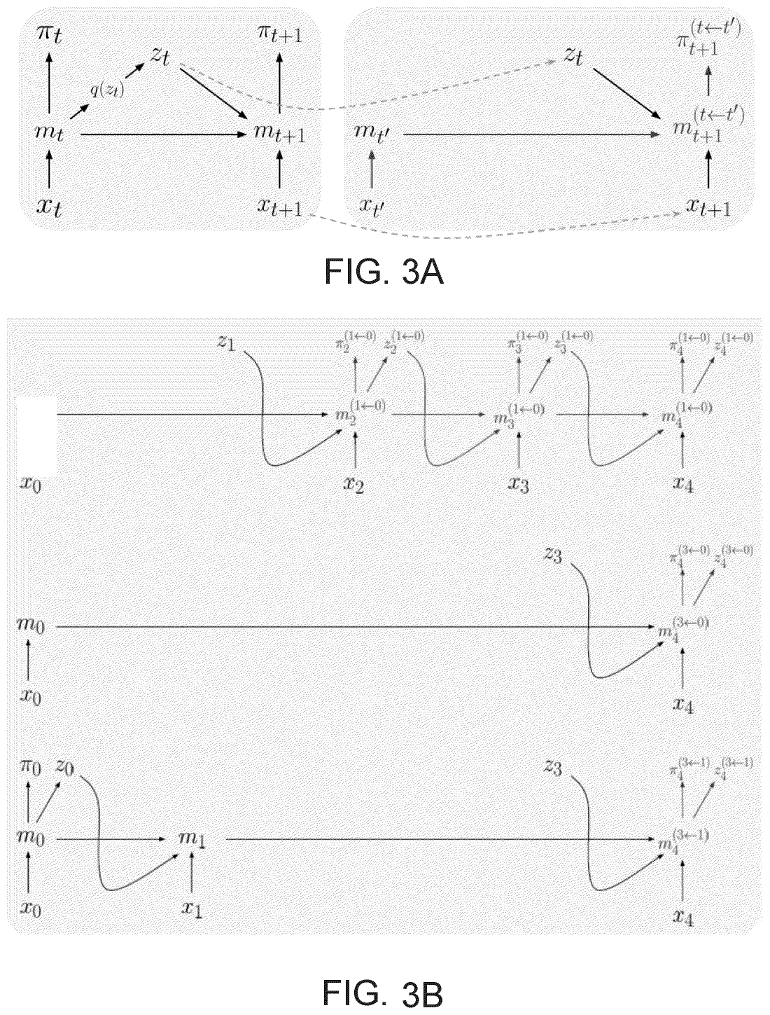

FIG. 3A illustrates the processing steps performed for an intervention in which a counterfactual internal state m_{t′} is used instead of mₜ when updating the internal state. FIG. 3B illustrates some examples of such interventions in which, from top to bottom, (t=1←t=0), (t=3←t=0), and (t=3←t=1). For example when (t=3←t=1) the internal state m₄ is reverted to m₁ and z₃ rather than m₃ must inform the system about the current state.

In some implementations the machine learning system 100 comprises a reinforcement learning system and is trained using a reinforcement learning objective function, e.g. as described above, without modification. In that case the system can be trained to maximize the return as previously described whilst the interventions are performed.

Also or instead the objective function may include or consist of one or more other components. For example the objective function may comprise a term that encourages accurate reconstructions of the internal state at the next time step, e.g. a term [symbol] _{M}=∥mₜ₊₁^{(t←t′)}−mₜ₊₁∥².

As another example the objective function may comprise a term that encourages the action selection policy under the intervention to match the policy without the intervention, e.g. a term [symbol] _{P}=Σ_{Δt>0}γ(Δt)·D_{KL}(π_{t+Δt}∥π_{t+Δt}^{(t←t′)}) where Δt defines a block of time steps, γ(·) defines a discount factor (which may be unity), π_{t+Δt}^{(t←t′)} and π_{t+Δt} are the respective policies with and without the intervention, and DKL (·) is a KL-divergence.

In some implementations when training using a counterfactual internal state parameter updates can be limited, e.g. so that learnable parameters of the action selection subsystem 130 are not updated, to limit disruption to the action selection policy. Where the objective function comprises the one or more terms described above the training may be performed entirely offline, and the objective function need not include a reinforcement learning component. That is the machine learning system 100 may be trained offline using an overall loss that comprises just the [symbol] _{M} or [symbol] _{P} term. This can separate the policy learning from training the parts of the system used to provide a causal explanation of the system's behavior, limiting any potential impact of this on the action selection policy.

In some implementations the user interface 170 can be used to modify the decoder output Zₜ, e.g. the above-described 1-hot vector or natural language representation, prior to its use in controlling the agent, i.e. prior to processing by the internal state updating subsystem 120.

The decoder output describes the environment 106 (it reflects the systems beliefs about the environment), and thus the system can be given (counterfactual) information about the environment, e.g. to impose a safety-related assumption, such as the speed limit is 30 mph when in fact it is 40 mph. Because the machine learning system 100 relies on the decoder output Zₜ to select an action, the (counterfactual) information from the user interface can change the actions selected and the agent's behavior.

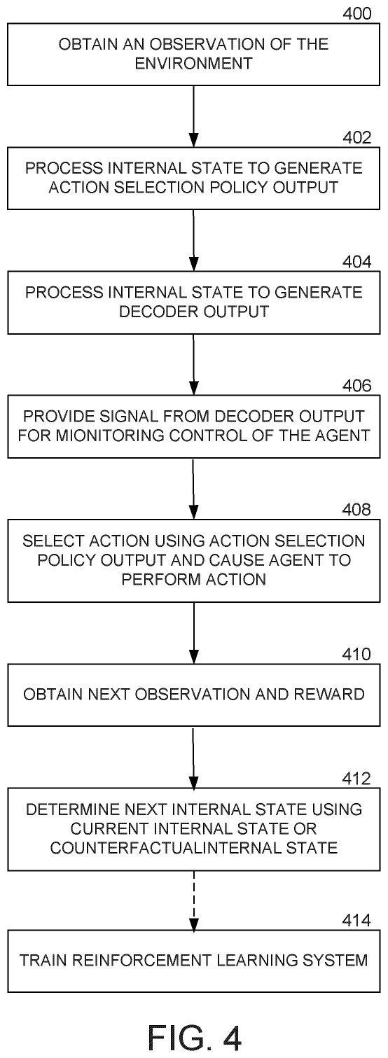

FIG. 4 is a flow diagram of a first example process for training a machine learning system. The process of FIG. 4 may be implemented by one or more computers in one or more locations, e.g. on the reinforcement learning neural network system 100. The process can be performed for each of a succession of time steps. The steps of FIG. 4 need not be performed in the order shown.

At step 400 the process obtains an observation characterizing a state of the environment for a current time step t. Also at the current time step the internal state of the machine learning system, mₜ, is processed using the action selection subsystem 130, to generate the action selection policy output 132 (step 402). The internal state of the machine learning system, mₜ, is also processed using the decoder neural network 140 to generate the decoder output for the current time step, zₜ (step 404), which can be output. In implementations the method provides a signal derived from the decoder output for the current time step as a monitoring signal for monitoring the control of the agent by the machine learning system in the environment (step 406). An action is selected using the action selection policy output 132 and performed by the agent (step 408), and a next observation and reward is received (step 410).

The process determines the internal state of the machine learning system at the next time step by processing a combination of the decoder output for the current time step, the observation for the next time step, and an internal state, using the internal state updating subsystem 120. At some time steps a combination of the decoder output for the current time step, the observation for the next time step, and the internal state at the current time step is processed (step 412). At some time steps, e.g. at each intervention time step, a combination of the decoder output for the current time step, the observation for the next time step, and a counterfactual internal state is processed (step 412).

An intervention time step is a time step when an intervention is performed according to an intervention schedule. The intervention time step may be any or each time step (in implementations, after the first time step). In some implementations the intervention schedule comprises selecting randomly selecting time steps for the intervention.

In implementations the machine learning system 100 comprises a reinforcement learning system 100 and is trained using a reinforcement learning objective function based on the observations, the actions selected, and in implementations the rewards received; either online, whilst performing actions and receiving rewards, or offline (step 414).

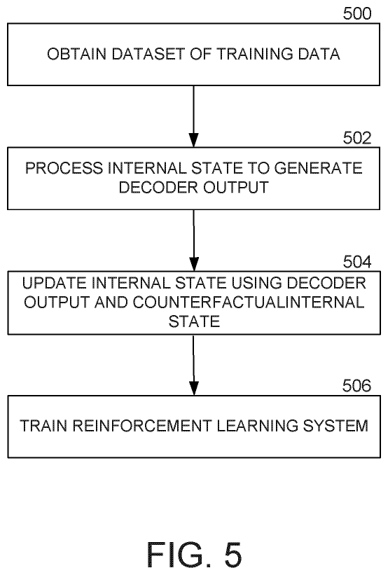

FIG. 5 is a flow diagram of a second example process for training machine learning system, in particular an agent control system, e.g. a reinforcement learning system, in particular for training a decoder neural network (and an internal state updating system) as described above. The process of FIG. 5 may be implemented by one or more computers in one or more locations, and can be performed offline i.e. using previously stored data without requiring the agent to interact further with the environment. For example the process of FIG. 5 can be used to train the machine learning system 100, optionally after training the system online, or it can be used for training another agent control system.

At step 500 the process obtains a dataset of training data, the training data comprising data defining an observation and an action for each of a succession of time steps. The training data may include reward data but need not (e.g. if behavioral cloning is used). In some implementations the training data has been obtained using the machine learning system 100 or another agent control system; in some implementations it may have be obtained from the actions of a human.

As an example, the dataset of training data may have been obtained whilst training the machine learning system 100 without the use of any counterfactual internal states. In more detail, in some implementations the training data has been obtained by, for each of the succession of time steps, obtaining an observation characterizing the state of the environment for a current time step, and processing an internal state of the system at the current time step, using an action selection subsystem, e.g. action selection subsystem 130, to generate an action selection policy output used to control the agent.

The dataset of training data is processed using the reinforcement learning or other agent control system for each of a succession of time steps (e.g. corresponding to the time steps in the dataset of training data). This involves processing the internal state of the system at the current time step using the decoder neural network to generate the decoder output for the current time step (step 502).

The internal state of the system at a next time step is determined by processing, using the internal state updating subsystem, the combination of the decoder output for the current time step, the observation for the next time step, and the counterfactual internal state (step 504). Some implementations of the process of FIG. 5 process the counterfactual internal state at each of the time steps. In some implementations of the process of FIG. 5 the succession of time steps for which the process is performed comprises a block of time steps; successive blocks of time steps may have different durations.

The reinforcement learning neural network system 100 or other agent control system is trained using an objective function that encourages the system to use the decoder output for the current time step to reconstruct the internal state for the next time step, or that encourages the system to recover the true current action selection policy, or both (step 506).

An objective function that encourages the system to use the decoder output for the current time step to reconstruct the internal state for the next time step can be an objective function that depends on a difference between a) the internal state of the agent control system at the next time step as determined by processing the counterfactual internal state, and b) an internal state of the agent control system at a next time step determined by processing, using the internal state updating subsystem, the combination of the decoder output for the current time step, the observation for the next time step, and the internal state of the agent control system at the current time step. Such an objective function may be evaluated for each of the time steps.

An objective function that encourages the system to recover the true current action selection policy can be an objective function that depends on a difference between a) an action selection policy of the action selection subsystem determined from the internal state of the agent control system at the current time step, and b) an action selection policy of the action selection subsystem determined from the counterfactual internal state. Such an objective function may be evaluated for a block of time steps. The difference between the action selection policies may be determined by a metric of a difference in distributions defined by the action selection policy outputs, e.g. determined as a sum of differences between the action selection policies over a trajectory of multiple time steps.

As previously described, in some implementations of the above systems the decoder output zₜ is expressed in semantically-meaningful terms. Whilst not essential, this can be facilitated by training the decoder output zₜ based on ground-truth knowledge of the environment. For example where the task of the agent is to move to the location of a specified object the ground-truth knowledge may be identification of the location of the specified object, e.g. as a 1-hot vector or in natural language such as “The <specified object> is in the <object location>”. This information is relevant to the task (in the example, required by the task) and hence compatible with information that the system will need to use to perform the task. The decoder neural network 140 can be trained e.g. using supervised learning, based on such ground-truth knowledge. Such ground-truth knowledge may only be needed for a few training examples.

Thus some implementations of the processes of FIGS. 4 and 5 can include training the decoder neural network, i.e. updating learnable parameters, such as weights, of the decoder neural network, using supervised training based on a decoder training objective function. The decoder training objective function may be any suitable loss function that depends on a difference between the description of the internal state of the machine learning system (at the current time step) from the decoder output (for the current time step), and a ground truth description of the environment (for the current time step).

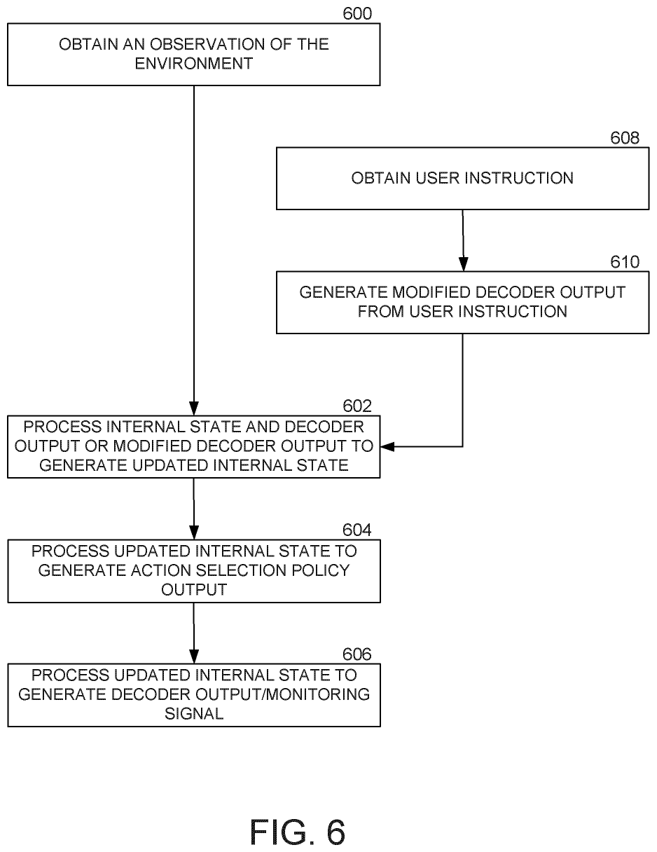

FIG. 6 is a flow diagram of an example process for monitoring, and optionally intervening in, the control of an agent in an environment performing a task. The process of FIG. 6 may be implemented by one or more computers in one or more locations, e.g. by a reinforcement learning or other agent control system as described above after the system has been trained. The steps of FIG. 6 may be performed in a different order to that shown.

At each time step the process obtains an observation characterizing a state of the environment (step 600). One or more of the observations may include a description of a task to be performed. The internal state updating subsystem 120 processes the internal state for a current time step t, mₜ, in combination with the current decoder output, zₜ, and a representation of the observation for the next time step, xₜ₊₁, to generate the updated internal state, mₜ₊₁ (step 602). The action selection subsystem 120 processes the updated internal state, mₜ₊₁, to generate the action selection policy output 132 for the next time step for selecting an action to be performed by the agent 104 (step 604). The decoder neural network 140 processes the updated internal state, mₜ₊₁, to generate the decoder output, Zₜ₊₁, for the next time step, to provide the monitoring signal 142 monitoring the control of the agent in the environment, e.g. via the user interface 170 (step 606).

In some implementations the user interface 170, or another user interface, is used for controlling the behavior of the agent in the environment. The signal derived from the decoder output, e.g. for a current time step, may be provided to the user via a user interface as previously described. The process may also include receiving an instruction from the user interface that relates to performance of the task in the environment, e.g. to redefine a belief of the machine learning system about the environment by specifying one or more aspects or characteristics of the environment (step 608). A modified decoder output is then generated from the instruction, e.g. by modifying the natural language or 1-hot representation accordingly (step 610). The modified decoder output is then used in the current time step instead of the true decoder output for the current time step (step 602).

The internal state updating subsystem 120 can process a combination of the modified decoder output for the current time step, the observation for the next time step, and the internal state of the machine learning system at the current time step, to generate the updated internal state (step 612). In this way the beliefs of the machine learning system about the environment are modified to guide the behavior of the agent. Unlike approaches where instructions are provided as an input to control a machine learning system, using the described techniques the machine learning system commits to following an output from the system, i.e. the decoder output zₜ, which is modified and fed back into the system, specifically into the internal state updating unit 120.

In a variant of the process of FIG. 6 the observations of the environment may be obtained offline, from data previously collected whilst using the machine learning system 100 to select actions for the agent, and the process used to analyze and explain the behavior of the agent based on these.

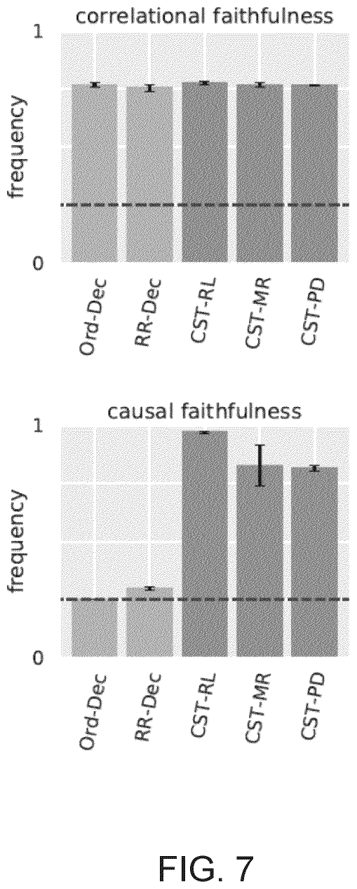

FIG. 7 illustrates the performance of some implementations of the above described techniques. In FIG. 7 CST-RL refers to an implementation the process of FIG. 4, CST-MR refers to an implementation the process of FIG. 5 where the overall loss includes the [symbol] _{M} term, and CST-PD refers to an implementation the process of FIG. 5 where the overall loss includes the [symbol] _{P} term. Ord-Dec refers to a technique in which zₜ is not used for updating the internal state of the system but merely provides an output; and RR-Dec refers to a technique in which zₜ is used for updating the internal state of the system but in which a counterfactual internal state is not used. The different techniques perform similarly well when considering correlational faithfulness but only those that use a counterfactual internal state exhibit causal faithfulness, i.e. where the information in the decoder output zₜ and monitoring signal 142 have a causal effect on the actions selected by the system.

The techniques described herein are widely applicable and are not limited to one specific implementation. However, for illustrative purposes, a small number of example implementations are described below.

In some implementations the agent is a mechanical agent, the environment is a real-world environment, the observation are from one or more sensors sensing the real-world environment, and the actions control the mechanical agent acting in the real-world environment to perform the task.

In more detail, in some implementations the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator.

For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the machine learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmachemical drug and the agent is a computer system for determining elements of the pharmachemical drug and/or a synthetic pathway for the pharmachemical drug. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources e.g. on a mobile device and/or in a data center. In these implementations, the actions may include assigning tasks to particular computing resources.

Thus in some applications the agent is a software agent and the environment is a real-world computing environment. In one example the agent manages distribution of tasks across computing resources e.g. on a mobile device and/or in a data center. In these applications, the observations may include observations of computing resources such as compute and/or memory capacity, or Internet-accessible resources; and the actions may include assigning tasks to particular computing resources. The reward(s) may be configured to maximize or minimize one or more of: utilization of computing resources, electrical power, bandwidth, and computation speed.

In another example the software agent manages the processing, e.g. by one or more real-world servers, of a queue of continuously arriving jobs. The observations may comprise observations of the times of departures of successive jobs, or the time intervals between the departures of successive jobs, or the time a server takes to process each job, e.g. the start and end of a range of times, or the arrival times, or time intervals between the arrivals, of successive jobs, or data characterizing the type of job(s). The actions may comprise actions that allocate particular jobs to particular computing resources; the reward(s) may be configured to minimize an overall queueing or processing time or the queueing or processing time for one or more individual jobs, or in general to optimize any metric based on the observations.

As another example the environment may comprise a real-world computer system or network, the observations may comprise any observations characterizing operation of the computer system or network, the actions performed by the software agent may comprise actions to control the operation e.g. to limit or correct abnormal or undesired operation e.g. because of the presence of a virus or other security breach, and the reward(s) may comprise any metric(s) that characterizing desired operation of the computer system or network.

In some applications, the environment is a real-world computing environment and the software agent manages distribution of tasks/jobs across computing resources e.g. on a mobile device and/or in a data center. In these implementations, the observations may comprise observations that relate to the operation of the computing resources in processing the tasks/jobs, the actions may include assigning tasks/jobs to particular computing resources, and the reward(s) may relate to one or more metrics of processing the tasks/jobs using the computing resources, e.g. metrics of usage of computational resources, bandwidth, or electrical power, or metrics of processing time, or numerical accuracy, or one or more metrics that relate to a desired load balancing between the computing resources.

In some applications the environment is a data packet communications network environment, and the agent is part of a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The task-related reward(s) may be defined in relation to one or more of the routing metrics i.e. configured to maximize one or more of the routing metrics.

In some other applications the environment is an Internet or mobile communications environment and the agent is a software agent which manages a personalized recommendation for a user. The observations may comprise previous actions taken by the user, e.g. features characterizing these; the actions may include actions recommending items such as content items to a user. The task-related reward(s) may be configured to maximize one or more of: an estimated likelihood that the user will respond favorably to being recommended the (content) item, a suitability unsuitability of one or more recommended items, a cost of the recommended item(s), and a number of recommendations received by the user, optionally within a time span.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

The environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training or evaluation or both are complete, may be deployed for controlling a real-world agent in the particular real-world environment that was the subject of the simulation. This can avoid unnecessary wear and tear on and damage to the real-world environment or real-world agent and can allow the system to be trained or evaluated in situations that occur rarely or are difficult or unsafe to re-create in the real-world environment. In such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method of training a machine learning system configured to monitor the control of an agent in an environment performing a task, wherein the machine learning system is configured to, for each of a succession of time steps:
obtain an observation characterizing a state of the environment for a current time step;
process an internal state of the machine learning system at the current time step using an action selection subsystem of the machine learning system to generate an action selection policy output, wherein the internal state of the machine learning system at the current time step depends on the observation for the current time step;
process the internal state of the machine learning system at the current time step using a decoder neural network to generate a decoder output for the current time step, wherein the decoder output for the current time step describes the internal state of the machine learning system at the current time step;
select an action to be performed by the agent at the current time step in response to the observation using the action selection policy output;
cause the agent to perform the selected action; and
provide a signal derived from the decoder output for the current time step as a monitoring signal for monitoring the control of the agent in the environment;
the method comprising training the machine learning system by:
determining the internal state of the machine learning system at a next time step by processing, using an internal state updating subsystem, a combination of the decoder output for the current time step, the observation for the next time step, and a counterfactual internal state, wherein the counterfactual internal state is different to the internal state of the machine learning system at the current time step.

2. The method of claim 1, wherein training the machine learning system further comprises, for each of the succession of time steps:
obtaining the observation characterizing the state of the environment for the current time step;
processing the internal state of the machine learning system at the current time step using the action selection subsystem of the machine learning system to generate the action selection policy output;
processing the internal state of the machine learning system at the current time step using the decoder neural network to generate the decoder output for the current time step;
selecting the action to be performed by the agent at the current time step in response to the observation using the action selection policy output;
causing the agent to perform the selected action wherein, in response to causing the agent to perform the selected action, the machine learning system receives a reward; and
training the machine learning system using the observations, the actions selected using the action selection policy output, and the rewards, by backpropagating gradients of a reinforcement learning objective function into the machine learning system; and wherein the training includes:
determining the internal state of the machine learning system at the next time step by processing, using the internal state updating subsystem, the combination of the decoder output for the current time step, the observation for the next time step, and the counterfactual internal state.

3. The method of claim 2, wherein determining the internal state of the machine learning system at the next time step by processing the combination of the decoder output for the current time step, the observation for the next time step, and the counterfactual internal state defines an intervention performed according to an intervention schedule, wherein the intervention schedule comprises selecting randomly selecting time steps for the intervention.

4. The method of claim 2, or 3, wherein the training comprises, for each of a plurality of intervention time steps after a first of the time steps, determining the internal state of the machine learning system at the next time step by processing, using the internal state updating subsystem, the combination of the decoder output for the current time Page step, the observation for the next time step, and the counterfactual internal state; and for other time steps,
determining the internal state of the machine learning system at the next time step by processing, using the internal state updating subsystem, the combination of the decoder output for the current time step, the observation for the next time step, and the internal state at the current time step.

5. The method of claim 1, further comprising:
obtaining a dataset of training data, the training data comprising data defining an observation and an action for each of a succession of time steps, the training data having been obtained by, for each of the succession of time steps:
obtaining an observation characterizing the state of the environment for a current time step; and
processing the internal state of the machine learning system at the current time step using the action selection subsystem of the machine learning system to generate the action selection policy output; and
processing the dataset of training data by, for each of a succession of time steps:
processing the internal state of the machine learning system at the current time step using the decoder neural network to generate the decoder output for the current time step;
and wherein processing the dataset of training data includes:
determining the internal state of the machine learning system at a next time step by processing, using the internal state updating subsystem, the combination of the decoder output for the current time step, the observation for the next time step, and the counterfactual internal state; and further comprising
training the machine learning system using an objective function that depends on either:
i) a difference between a) the internal state of the agent control system at the next time step as determined by processing the counterfactual internal state, and b) an internal state of the agent control system at a next time step determined by processing, using the internal state updating subsystem, the combination of the decoder output for the current time step, the observation for the next time step, and the internal state of the agent control system at the current time step; or
ii) a difference between a) an action selection policy of the action selection subsystem determined from the internal state of the agent control system at the current time step, and b) an action selection policy of the action selection subsystem determined from the counterfactual internal state.

6. The method of claim 5, wherein the objective function depends on the difference between the internal states of the agent control system, and wherein determining the internal state of the agent control system at the next time step by processing, using the internal state updating subsystem, the combination of the decoder output for the current time step, the observation for the next time step, and the counterfactual internal state defines an intervention performed according to an intervention schedule, and wherein the intervention schedule comprises performing the intervention at each of the time steps.

7. The method of claim 5, wherein the objective function depends on the difference between the action selection policies, wherein determining the internal state of the agent control system at the next time step by processing, using the internal state updating subsystem, the combination of the decoder output for the current time step, the observation for the next time step, and the counterfactual internal state defines an intervention performed according to an intervention schedule, and wherein the intervention schedule is defined by dividing the time steps into a sequence of blocks of time steps of variable duration and performing the intervention at each block of time steps.

8. The method of claim 5, wherein the difference between the action selection policies comprises a metric of a difference in distributions defined by the action selection policy outputs.

9. The method of claim 5, wherein the difference between the action selection policies comprises a sum of differences between the action selection policies over a plurality of the time steps.

10. The method of claim 1, wherein the counterfactual internal state comprises the internal state of the machine learning system at an earlier time step than the current time step.

11. The method of claim 10, wherein the counterfactual internal state comprises the internal state of the machine learning system at a first time step.

12. The method of claim 1, wherein the decoder output for the current time step comprises a vector having elements that each represent a respective one of a plurality of discrete internal states of the machine learning system.

13. The method of claim 1, wherein the decoder output for the current time step comprises a natural language description of the internal state of the machine learning system.

14. The method of claim 1, further comprising:
modifying the decoder output for the current time step, and
determining the internal state of the machine learning system at a next time step by processing, using the internal state updating subsystem, a combination of the modified decoder output for the current time step, the observation for the next time step, and the counterfactual internal state.

15. The method of claim 14, further comprising controlling the behavior of the agent in the environment by:
outputting the signal derived from the decoder output for the current time step via a user interface;
receiving an instruction from the user interface, wherein the instruction relates to performance of the task in the environment; and
generating the modified decoder output from the instruction.

16. The method of claim 1, wherein the action selection subsystem comprises an action selection policy neural network of the machine learning system.

17. The method of claim 1, wherein the internal state updating subsystem comprises a recurrent neural network.

18. The method of claim 1, wherein the internal state updating subsystem comprises a transformer neural network.

19.-25. (canceled)

26. A system comprising one or more computers and one or more storage devices storing instructions that are operable, when executed by the one or more computers, to cause the one or more computers to perform operations for training a machine learning system configured to monitor the control of an agent in an environment performing a task, wherein the machine learning system is configured to, for each of a succession of time steps:
obtain an observation characterizing a state of the environment for a current time step;
process an internal state of the machine learning system at the current time step using an action selection subsystem of the machine learning system to generate an action selection policy output, wherein the internal state of the machine learning system at the current time step depends on the observation for the current time step;
process the internal state of the machine learning system at the current time step using a decoder neural network to generate a decoder output for the current time step, wherein the decoder output for the current time step describes the internal state of the machine learning system at the current time step;
select an action to be performed by the agent at the current time step in response to the observation using the action selection policy output;
cause the agent to perform the selected action; and
provide a signal derived from the decoder output for the current time step as a monitoring signal for monitoring the control of the agent in the environment;
the operations for training the machine learning system comprising:
determining the internal state of the machine learning system at a next time step by processing, using an internal state updating subsystem, a combination of the decoder output for the current time step, the observation for the next time step, and a counterfactual internal state, wherein the counterfactual internal state is different to the internal state of the machine learning system at the current time step.

27. A computer storage medium encoded with instructions that, when executed by one or more computers, cause the one or more computers to perform operations for training a machine learning system configured to monitor the control of an agent in an environment performing a task. wherein the machine learning system is configured to, for each of a succession of time steps:
obtain an observation characterizing a state of the environment for a current time step;
process an internal state of the machine learning system at the current time step using an action selection subsystem of the machine learning system to generate an action selection policy output, wherein the internal state of the machine learning system at the current time step depends on the observation for the current time step;
process the internal state of the machine learning system at the current time step using a decoder neural network to generate a decoder output for the current time step, wherein the decoder output for the current time step describes the internal state of the machine learning system at the current time step;
select an action to be performed by the agent at the current time step in response to the observation using the action selection policy output;
cause the agent to perform the selected action; and
provide a signal derived from the decoder output for the current time step as a monitoring signal for monitoring the control of the agent in the environment;
the operations for training the machine learning system comprising:
determining the internal state of the machine learning system at a next time step by processing, using an internal state updating subsystem, a combination of the decoder output for the current time step, the observation for the next time step, and a counterfactual internal state, wherein the counterfactual internal state is different to the internal state of the machine learning system at the current time step.
